(19) United States
(12) Patent Application Publication
(10) Pub. No.: US 2010/0154912 A1
(43) Pub. Date: Jun. 24, 2010

(54) HOSE

(76) Inventor: Chao-Chung WU, Taichung City (TW)

Correspondence Address: Dr. BANGER SHIA;Patent Office of Bang Shia, 102 Lindencrest Ct, Sugar Land, TX, 77479-5201, US

(21) Appl. No.: 12/343,752

(22) Filed: Dec. 24, 2008

(51) Int. Cl. F16L 55/10

(52) U.S. Cl. 138/89

(57) ABSTRACT

A hose is provided by the present invention. The hose includes a nut cap and a hose member with two openings on both ends thereof. On at least one end of the hose member is disposed an outer sleeve and an inner metal sleeve. In which, the outer sleeve sleeves around an outer periphery of the hose member, and one end thereof proximate to the opening is radially and outwardly extended a first rim. Moreover, the inner metal sleeve has an initial outer diameter smaller than a bore diameter of the hose member so as to be installed therein, and the inner metal sleeve is then enlarged in a stamping manner to form an enlarged section, such that the hose member is tightly gripped between the outer and inner metal sleeves. Thereby, the hose member, the outer and inner metal sleeves are tightly fastened up, and the bore diameter of the opening of the hose is close to, or even equal to, that of the hose member.

### BACKGROUND OF THE INVENTION

1. Field of the Invention

The present invention relates to a hose capable of combining with a sanitary apparatus.

2. Description of the Prior Art

As depicted in Taiwan patents, application No. 083210172, 084207368 and 085206064, a conventional hose normally includes a hose member, an outer sleeve and an inner sleeve with ratchet teeth around its outer periphery. To combine these three parts, two of the most common methods are listed as follow:

1. The inner sleeve has an outer diameter bigger than a bore diameter of the hose member, so that the inner sleeve has to be stuffed into the hose member with adequate axial force.

2. Or, the inner sleeve may have an outer diameter substantially equal to a bore diameter of the hose member instead. Therefore, it is necessary to exert pressure upon the outer sleeve to narrow it, so as to grip the hose member between the inner and outer sleeves.

However, both methods require that the inner sleeve to have a bigger thickness to bear the pressure without deformation, which means that the bore diameter of the hose is inevitably sacrificed.

### SUMMARY OF THE INVENTION

The main object of the present invention is to provide a hose which the hose member, the inner and outer sleeves are fastened up tightly.

Another main object of the present invention is to provide a hose that a bore diameter thereof is close to or equal to that of the hose member.

To achieve the above object, a hose of the present invention includes a nut cap and a hose member with two openings on both ends thereof. On at least one end of the hose member is disposed an outer sleeve and an inner metal sleeve. In which, the outer sleeve sleeves around an outer periphery of the hose member, and one end thereof proximate to the opening is radially and outwardly extended a first rim. Moreover, the inner metal sleeve has an initial outer diameter smaller than a bore diameter of the hose member so as to be installed therein, and the inner metal sleeve is then enlarged in a stamping manner to form an enlarged section, such that the hose member is tightly gripped between the outer and inner metal sleeves.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an explosive drawing showing a hose in accordance with a preferred embodiment of the present invention;

FIG. 2 is a schematic drawing showing a hose in accordance with a preferred embodiment of the present invention;

FIG. 3 is a partial profile showing a hose in accordance with a preferred embodiment of the present invention.

### DETAILED DESCRIPTION OF THE PREFERRED EMBODIMENTS

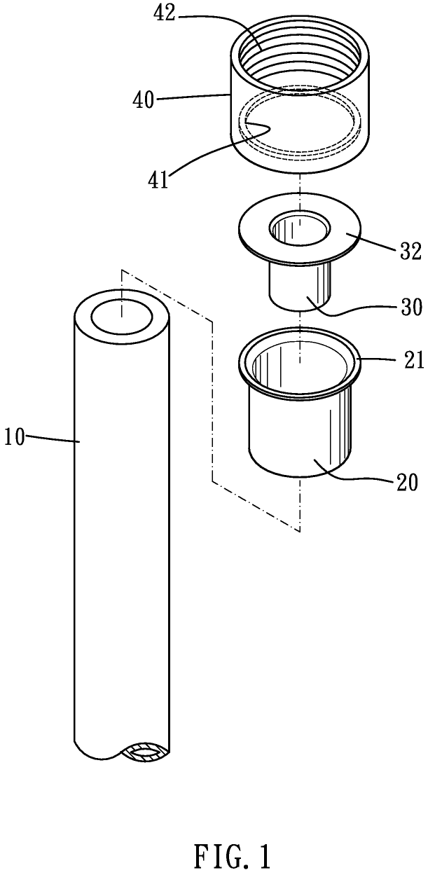

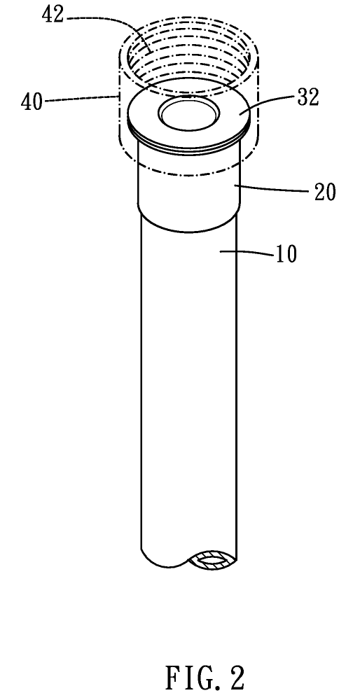

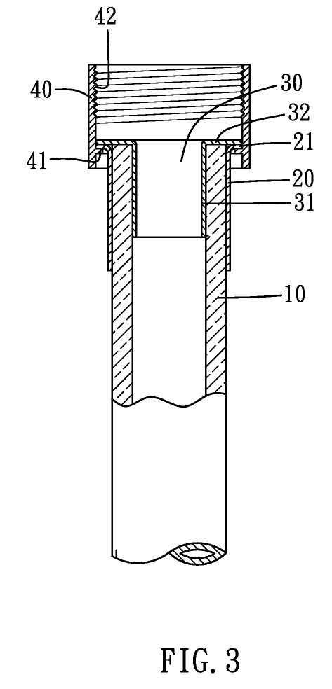

Please refer to FIG. 1 to FIG. 3. A hose includes a hose member 10 with two openings (only one of them is depicted) on both ends thereof. On at least one end of the hose member 10 is disposed an outer sleeve 20 and an inner metal sleeve 30. The outer sleeve 20 sleeves around an outer periphery of the hose member 10, and one end thereof proximate to the opening is radially and outwardly extended a first rim 21. The inner metal sleeve 30 has an initial outer diameter smaller than a bore diameter of the hose member 10 so as to be installed in the hose member 10, and the inner metal sleeve 30 is then enlarged in a stamping manner to form an enlarged section 31, such that the hose member 10 is tightly gripped between the outer sleeve 20 and the inner metal sleeve 30. In addition, it is preferred that one end of the inner metal sleeve 30 proximate to the opening is also radailly and outwardly extended a second rim 32, and the thickness of the inner metal sleeve 30 is between 0.2 mm to 0.4 mm. The material of the inner metal sleeve 30 is preferred to have greater malleability, such as copper.

The hose further includes a nut cap 40. One end of the nut cap 40 has an inner flange 41 with an inner diameter smaller than an outer diameter of the first rim 21 yet bigger than an outer diameter of the hose member 10, such that the nut cap 40 sleeves the outer sleeve 20 and the inner flange 41 is hookable with the first rim 21. Another end thereof has a threaded section 42 to screw with a sanitary apparatus, i.e. a shower head.

In the present invention, the hose member 10 can be made from plastic or metal material. Preferably, the hose member 10 can be made with patterns around its surface, so that the inner metal sleeve can be stamped into the shape corresponding to the patterns to get better gripping force.

Based on the above-mentioned description, it is readily to be understood that the hose of the present invention is designed to realize the follow efficacy:

1. The initial outer diameter of the inner metal sleeve is not bigger than the bore diameter of the hose member; therefore the metal sleeve can be installed into the hose without much effort, which means it is very easy and convenient to position the inner metal sleeve.

2. When the metal sleeve is disposed in the hose member, it is processed to form an enlarged section with bigger outer diameter in a stamping manner. Therefore, the bore diameter of the hose can be made equal to, or at least close to that of the hose member rather than inevitably sacrificed as conventional art is.

3. To bear the pressure during the process of positioning the three parts of the hose, the thickness of the inner sleeve of a conventional hose is increased to get better mechanic strength; on the contrary, the parts of the present invention is positioned in a stamping manner, so that the bore diameter of the hose is enlarged, the hose member, the outer and the inner metal sleeves is fastened up tightly and the thickness of the inner metal sleeve is thinner which reduces the consumption of the material, lowering the manufacturing cost.

4. A second rim is disposed on one end of the inner metal sleeve to gain better mechanical strength, and it is also an easy way to position the metal sleeve in the hose member during the stamping process. What's more, the second rim prevents the hose member from exposure as well.

While we have shown and described various embodiments in accordance with the present invention, it should be clear to those skilled in the art that further embodiments may be made without departing from the scope of the present invention.

What is claimed is:

1. A hose, comprising
a hose member with two openings on both ends thereof, on at least one end of the hose member disposed an outer sleeve and an inner metal sleeve, the outer sleeve sleeving around an outer periphery of the hose member, and one end of the outer sleeve proximate to the opening being radially and outwardly extended a first rim, the inner metal sleeve having an initial outer diameter substantially smaller than a bore diameter of the hose member so as to be installed in the hose member, and the inner metal sleeve being then enlarged in a stamping manner to form an enlarged section, such that the hose member being tightly gripped between the outer and inner metal sleeves; and
a nut cap, one end thereof having an inner flange which is hookable with the first rim of the outer sleeve, and another end thereof having a threaded section.

2. The hose as claimed in claim 1, wherein one end of the inner metal sleeve proximate to the opening being radially and outwardly extended a second rim.

3. The hose as claimed in claim 1, wherein a thickness of the inner metal sleeve is between 0.2 mm to 0.4 mm.
